(19) United States
(12) Patent Application Publication
(10) Pub. No.: US 2024/0287224 A1
(43) Pub. Date: Aug. 29, 2024

(54) POLYETHYLENE COPOLYMER FOR A FILM LAYER

(71) Applicant: BOREALIS AG, Vienna (AT)

(72) Inventors: Qizheng DOU, Linz (AT); Friedrich BERGER, Linz (AT); Matthias HOFF, Linz (AT)

(73) Assignee: BOREALIS AG, Vienna (AT)

(21) Appl. No.: 18/572,917

(22) PCT Filed: Jun. 23, 2022
(86) PCT No.: PCT/EP2022/067194

§ 371 Date: Dec. 21, 2023

(30) Foreign Application Priority Data
Jun. 24, 2021 (EP) 21181466.0

(51) Int. Cl. C08F 210/16; C08F 4/64; C08J 5/18

(52) U.S. Cl. CPC C08F 210/16; C08F 4/64006; C08J 5/18; C08F 2420/07; C08J 2323/08

(57) ABSTRACT

The present disclosure relates to a metallocene-catalysed multimodal polyethylene copolymer, and to use of the multimodal copolymer of ethylene in film applications, and to a film including a polymer composition of the disclosure.

The present invention relates to a metallocene-catalysed multimodal polyethylene copolymer (P), to the use of the multimodal polyethylene copolymer (P) in film applications and to a film comprising the polymer composition of the invention.

State of the art mLLDPE (metallocene catalysed linear low density polyethylene) is widely used everywhere in daily life, like packaging, due to its excellent cost/performance ratios.

One of the famous drawback is the narrow molecular weight distribution and therefore less shear thinning, which leads to the problem in film conversion, e.g. limiting the throughput.

WO 2021009189, WO 2021009190 and WO 2021009191 of Borealis disclose a process for preparing multimodal PE polymers in two loop reactors and one gas phase reactor.

The polymers produced in the Examples have a total density of 938 or 939 kg/m³. The MFR₂ (190° C., 2.16 kg, ISO 1133) of the polymer components produced in the first loop reactor is 22 g/10 min. Film properties, like tensile modulus (TM) and dart drop impact strength (DDI) are not mentioned at all.

Also WO 2021009192 discloses such a process. The polymer produced in the Examples has an even higher density of 951 kg/m³. The MFR₂ (190° C., 2.16 kg, ISO 1133) of the polymer component produced in the first loop is 32 g/10 min. Film properties, like tensile modulus (TM) and dart drop impact strength (DDI) are not mentioned at all.

WO2021013552, Reference Example RE3 discloses a polymer comprising an ethylene-1-butene polymer component and an ethylene-1-hexene polymer component, produced in one loop reactor and one gas phase reactor using as metallocene complex bis(I-methyl-3-n-butylcyclopentadienyl) zirconium (IV) dichloride. Films produced with such a polymer have a dart drop impact strength of 345 g only.

WO2021191018 disclose a process for preparing multimodal PE polymers in two loop reactors and one gas phase reactor using as metallocene complex bis(I-methyl-3-n-butylcyclopentadienyl) zirconium (IV) dichloride. The polymer according to IE1 has a MFR₂ of the polymer produced in the gas phase reactor of 1.65 g/10 min. The film made with this polymer has quite high haze of 42.2% WO2016083208 again discloses a polymer comprising an ethylene-1-butene polymer component and an ethylene-1-hexene polymer component, produced in one loop reactor and one gas phase reactor using as metallocene complex bis(I-methyl-3-n-butylcyclopentadienyl) zirconium (IV) dichloride. Film properties, like dart drop impact strength (DDI) are not mentioned at all.

US2014194277 discloses blends of two different separately produced (each in one reactor only) polyethylene copolymers (A) and (B). Film properties, like dart drop impact strength (DDI) are not mentioned at all.

Although a lot of development work has already been done in this field, there is still a continuous need to find multimodal PE polymers with different property balances for providing tailored solutions to meet the increasing demands of the end application producers e.g. for reducing the production costs while maintaining or even improving the end product properties. Tailored polymer solutions are also needed to meet the requirements of continuously developing equipment technology in the end application field.

A common problem in tailoring properties is, that very often an improvement of one property leads to a worsening of another property, e.g. by increasing the stiffness, very often the toughness drops down.

Therefore, there is a need in the art for providing a material that provides well-balanced mechanical properties, especially dart drop (impact strength) and tensile modulus; i.e. high stiffness as well as high toughness.

In other words, a material is desirable that provides an advantageous combination of tensile modulus and dart drop, to films prepared from such a material.

In addition, such films should further show a well-balanced and continuously improved overall performance.

Such an improvement in the overall performance of a blown film can be expressed by the optomechanical ability (OMA), which is the ratio of mechanical (especially dart-drop impact strength (DDI) and tensile (MD)) behaviour, to optical performance, namely haze.

It has now been found, that a metallocene-catalysed multimodal polyethylene copolymer (P) made with a specific metallocene catalyst and having a specific polymer design has such a desired improved performance.

The films made from such a metallocene-catalysed multimodal polyethylene copolymer (P) have in addition an improved balance of properties, especially in view of higher stiffness (i.e. tensile modulus) and higher impact strength (i.e. dart drop impact, DDI), as well as good optical properties.

### BRIEF DESCRIPTION OF THE DRAWINGS

FIG. 1 is a plot showing C6/wt % versus EHE/%; and

FIG. 2 shows a plot of Elution Temperature in C versus dw/dT.

### DESCRIPTION OF THE INVENTION

The present invention is therefore directed to a metallocene-catalysed multimodal polyethylene copolymer (P), which consists of
(i) 35.0 to 50.0 wt % of an ethylene-1-butene polymer component (A), and
(ii) 50.0 to 65.0 wt % of an ethylene-1-hexene polymer component (B),

whereby the ethylene-1-butene polymer component (A) has
a density in the range of from 920 to 950 kg/m³,
an MFR₂ (190° C., 2.16 kg, ISO 1133) in the range of from 2.0 to 20.0 g/10 min,
a 1-butene content in the range of 0.1 to 2.0 mol %, based on the ethylene-1-butene polymer component (A);
wherein ethylene-1-butene polymer component (A) consists of an ethylene-1-butene polymer fraction (A-1) and an ethylene-1-butene polymer fraction (A-2),
wherein the ethylene polymer fraction (A-1) has a density in the range of from 920 to 960 kg/m3 and an MFR2 (190° C., 2.16 kg, ISO 1133) in the range of from 1.0 to 15.0 g/10 min and
the ethylene polymer fraction (A-2) has a density in the range of from 925 to 950 kg/m³,
and an MFR2 and (190° C., 2.16 kg, ISO 1133) the range of 1.0 to 15.0 g/10 min,

the ethylene polymer component (B) has
a density in the range of from 890 to 920 kg/m³,
an MFR₂ (190° C., 2.16 kg, ISO 1133) in the range of from 0.1 to 2.0 g/10 min
a 1-hexene content in the range of 2.5 to 10.0 mol % based on the ethylene-1-hexene polymer compound (B);

whereby the multimodal polyethylene copolymer (P) has
a density in the range of from 915 to 925 kg/m³,
an MFR₂ (190° C., 2.16 kg, ISO 1133) in the range of from 1.0 to 3.0 g/10 min,
a molecular weight distribution, Mw/Mn, determined with GPC in the range of at least 4.6 up to 7.0,
a ratio of the weight average molecular weight, Mw, of the low crystalline fraction (LCF) to the weight average molecular weight, Mw, of the high crystalline fraction (HCF),
Mw(Tp(LCF)/Mw(Tp(HCF), determined as described in the experimental part, in the range of from 1.8 to 4.0 and
a half peak breadth of the low crystalline fraction (LCF) in a TREF profile with Log M>5.2, determined as described in the experimental part, in the range of 5.0 to 20.0

Unexpectedly the multimodal polyethylene copolymer (P) of the invention provides improved mechanical properties to films such as high dart drop strength (DDI) and at the same time good tensile modulus.

The invention is therefore further directed to a film comprising at least one layer comprising the metallocene-catalysed multimodal polyethylene copolymer (P).

In one further embodiment of the present invention, the optomechanical ability (OMA) according to formula (I):

$$OMA = \frac{Tensile Modulus ( MD ) [ MPa ] * DDI ( g )}{Haze ( 40 μm ) [ \% ]}$$

of films determined on 40 μm test blown film is at least 7800 [MPa*g/%] up to 15 000 [MPa*g/%], preferably in the range of from 8000 [MPa*g/%] up to 12 000 [MPa*g/%], more preferably in the range of from 8200 [MPa*g/%] up to 10 000 [MPa*g/%], wherein the Tensile Modulus in machine direction is measured according to ISO 527-3 at 23° C. on 40 μm test blown films, DDI is the dart-drop impact strength determined according to ASTM D1709, method A on a 40 μm test blown film and haze is measured according to ASTM D1003 on a 40 μm test blown film.

### Definitions

Where the term “comprising” is used in the present description and claims, it does not exclude other non-specified elements of major or minor functional importance. For the purposes of the present invention, the term “consisting of” is considered to be a preferred embodiment of the term “comprising of”. If hereinafter a group is defined to comprise at least a certain number of embodiments, this is also to be understood to disclose a group, which preferably consists only of these embodiments.

Whenever the terms “including” or “having” are used, these terms are meant to be equivalent to “comprising” as defined above.

Where an indefinite or definite article is used when referring to a singular noun, e.g. “a”, “an” or “the”, this includes a plural of that noun unless something else is specifically stated.

Metallocene catalysed multimodal polyethylene copolymer is defined in this invention as multimodal polyethylene copolymer (P), which has been produced in the presence of a metallocene catalyst.

Term “multimodal” in context of multimodal polyethylene copolymer (P) means herein multimodality with respect to melt flow rate (MFR) of the ethylene polymer components (A) and (B), i.e. the ethylene polymer components (A) and (B) have different MFR values. The multimodal polyethylene copolymer (P) can have further multimodality with respect to one or more further properties between the ethylene polymer components (A) and (B), as will be described later below.

The multimodal polyethylene copolymer (P) of the invention as defined above, below or in claims is also referred herein shortly as “multimodal PE” or “multimodal copolymer (P)”.

The following preferable embodiments, properties and subgroups of multimodal PE and the ethylene polymer components (A) and (B) thereof, as well as the ethylene polymer fractions (A-1) and (A-2) and the film of the invention including the preferable ranges thereof, are independently generalisable so that they can be used in any order or combination to further define the preferable embodiments of the multimodal PE and the article of the invention.

### Multimodal PE as Well as Ethylene Polymer Component (A) and (B) and Ethylene Polymer Fractions (A-1) and (A-2)

The metallocene produced multimodal polyethylene copolymer (P) is referred herein as “multimodal”, since the ethylene-1-butene polymer component (A), including ethylene polymer fractions (A-1) and (A-2), and ethylene-1-hexene polymer component (B) have been produced under different polymerization conditions resulting in different Melt Flow Rates (MFR, e.g. MFR₂). I.e. the multimodal PE is multimodal at least with respect to difference in MFR of the ethylene polymer components (A) and (B).

The metallocene produced multimodal polyethylene copolymer (P) consists of
(i) 35.0 to 50.0 wt % of an ethylene-1-butene polymer component (A), and
(ii) 50.0 to 65.0 wt % of an ethylene-1-hexene polymer component (B).

The amount of (A) and (B) add up to 100.0 wt %.

The ethylene-1-butene polymer component (A) consists of an ethylene polymer fraction (A-1) and (A-2), whereby the MFR₂ of the ethylene polymer fractions (A-1) and (A-2) may be different from each other or may be the same.

The ethylene polymer fraction (A-1) has an MFR₂ (190° C., 2.16 kg, ISO 1133) in the range of 1.0 to 15.0 g/10 min, preferably of 1.5 to 14.0 g/10 min, more preferably of 2.0 to 12.0 g/10 min, even more preferably of 2.5 to 12.0 g/10 min, and most preferably 3.0 to 10.0 g/10 min.

The ethylene polymer fraction (A-2) has an MFR₂ (190° C., 2.16 kg, ISO 1133) in the range of 1.0 to 15.0 g/10 min, preferably of 1.5 to 14.0 g/10 min, more preferably of 2.0 to 12.0 g/10 min, even more preferably of 2.5 to 12.0 g/10 min, and most preferably 3.0 to 10.0 g/10 min.

The MFR₂ of the ethylene polymer components (A) and (B) are different from each other.

The ethylene polymer component (A) has an MFR₂ (190° C., 2.16 kg, ISO 1133) in the range of 2.0 to 20 g/10 min, preferably of 2.5 to 16 g/10 min, more preferably of 3.0 to 12.0 g/10 min and even more preferably of 3.5 to 10 g/10 min.

The ethylene polymer component (B) has an MFR₂ (190° C., 2.16 kg, ISO 1133) in the range of 0.1 to 2.0 g/10 min, preferably of 0.2 to 1.6 g/10 min, more preferably of 0.3 to 1.2 g/10 min and even more preferably of 0.3 to 1.0 g/10 min.

The MFR₂ (190° C., 2.16 kg, ISO 1133) of the multimodal copolymer (P) is in the range of 1.0 to 3.0 g/10 min, preferably 1.0 to 2.5 g/10 min, more preferably 1.0 to 2.0 g/10 min.

Naturally, in addition to multimodality with respect to, i.e. difference between, the MFR₂ of ethylene polymer components (A) and (B), the multimodal PE of the invention can also be multimodal e.g. with respect to one or both of the two further properties: multimodality with respect to, i.e. difference between,
the comonomer content(s) present in the ethylene polymer components (A) and (B); and/or
the density of the ethylene polymer components (A) and (B).

Preferably, the multimodal copolymer (P) is further multimodal with respect to the comonomer content of the ethylene polymer components (A) and (B).

The comonomer type for the polymer fractions (A-1) and (A-2) is the same, thus both fractions therefore have 1-butene as comonomer.

The comonomer content of component (A) and (B) can be measured, or, in case, and preferably, one of the components is produced first and the other thereafter in the presence of the first produced in so called multistage process, then the comonomer content of the first produced component, e.g. component (A), can be measured and the comonomer content of the other component, e.g. component (B), can be calculated according to following formula:

Comonomer content (mol %) in component B=(comonomer content (mol %) in final product (weight fraction of component A* comonomer content (mol %) in component A))/(weight fraction of component B)

The total amount of 1-butene, based on the multimodal polymer (P) is preferably in the range of from 0.1 to 1.0 mol %, preferably 0.2 to 0.8 mol % and more preferably 0.2 to 0.6 mol %.

The total amount of 1-hexene, based on the multimodal polymer (P) preferably is in the range of 1.5 to 8.0 mol %, preferably 2.0 to 6.0 mol % and more preferably 2.2 to 4.0 mol %.

The total amount (mol %) of 1-butene, present in the ethylene-1-butene polymer component (A) is of 0.1 to 2.0 mol %, preferably of 0.2 to 1.6 mol %, more preferably of 0.3 to 1.2 mol %, even more preferably of 0.4 to 1.0 mol %, based on the ethylene-1-butene polymer component (A).

The total amount (mol %) of 1-hexene, present in the ethylene-1-hexene polymer component (B) is of 2.5 to 10.0 mol %, preferably of 3.0 to 8.0 mol %, more preferably of 3.5 to 6.0 mol %, based on the ethylene-1-hexene polymer component (B).

Even more preferably the multimodal polymer (P) of the invention is further multimodal with respect to difference in density between the ethylene polymer component (A) and ethylene polymer component (B). Preferably, the density of ethylene polymer component (A) is different, preferably higher, than the density of the ethylene polymer component (B).

The density of the ethylene polymer component (A) is in the range of 920 to 950 kg/m³, preferably of 925 to 945 kg/m³, more preferably 930 to 942 kg/m³ and/or the density of the ethylene polymer component (B) is of in the range of 890 to 920 kg/m³, preferably of 895 to 915 kg/m³ and more preferably of 900 to 912 kg/m³.

The polymer fraction (A-1) has a density in the range of from 920 to 960 kg/m³, preferably of 925 to 955 kg/m³, more preferably of 930 to 950 kg/m³, and most preferred 935 to 945 kg/m³.

The density of the polymer fraction (A-2) is in the range of from 925 to 950 kg/m³, preferably of 930 to 940 kg/m³.

The density of polymer fraction (A-1) and (A-2) may be the same or may be different from each other.

The metallocene catalysed multimodal copolymer (P) is preferably a linear low density polyethylene (LLDPE) which has a well known meaning.

The density of the multimodal copolymer (P) is in the range of 915 to 925 kg/m³, preferably of 916.0 to 922 kg/m³ and more preferably of 917.0 to 922.0 kg/m³.

More preferably the multimodal copolymer (P) is multimodal at least with respect to, i.e. has a difference between, the MFR₂, the comonomer content as well as with respect to, i.e. has a difference between the density of the ethylene polymer components, (A) and (B), as defined above, below or in the claims including any of the preferable ranges or embodiments of the polymer composition.

The multimodal copolymer (P) furthermore has a molecular weight distribution (Mw/Mn) determined with GPC in the range of at least 4.6 up to 7.0, preferably in the range of 4.8 to 6.8 and more preferably in the range of 5.0 to 6.5.

In addition, the multimodal copolymer (P) has a ratio of the weight average molecular weight (Mw) of the low crystalline fraction (LCF) to the weight average molecular weight (Mw) of the high crystalline fraction (HCF), Mw(Tp(LCF)/Mw(Tp(HCF), determined as described in the experimental part, in the range of from 1.4 to 4.0, preferably in the range of 1.8 to 3.5, and more preferably of 2.0 to 3.0.

The half peak breadth of the low crystalline fraction (LCF) in a TREF profile with Log M>5.2, determined as described in the experimental part, of the multimodal copolymer (P) is in the range of 5.0 to 20.0, preferably 6.0 to 16.0, more preferably 7.0 to 14.0 and even more preferably 8.0 to 12.0.

Definition of High crystalline fraction (HCF) and Low crystalline fraction (LCF): The high crystalline fraction (HCF) is the amount in wt % of the polymer fraction with a crystallisation temperature higher than 90° C., which mainly contains the homo-polyethylene chains or chains with a very low branching content.

The low crystalline fraction (LCF) is than the amount in wt % of the polymer fraction with a crystallisation temperature between 30 to below 90° C.

It is within the scope of the invention, that the first and the second ethylene polymer fraction (A-1 and A-2) of the ethylene polymer component (A) are present in a weight ratio of 4:1 up to 1:4, such as 3:1 to 1:3, or 2:1 to 1:2, or 1:1.

The ethylene polymer component (A) is present in an amount of 35.0 to 50.0 wt % based on the multimodal copolymer (P), preferably in an amount of 36.0 to 48.0 wt % and even more preferably in an amount of 38.0 to 45.0 wt %.

Thus, the ethylene polymer component (B) is present in an amount of 50.0 to 65.0 wt % based on the multimodal copolymer (P), preferably in an amount of 52.0 to 64.0 wt % and more preferably in an amount of 55.0 to 62.0 wt %.

The metallocene catalysed multimodal copolymer (P) can be produced with a 3-stage process, preferably comprising a first slurry reactor (loop reactor 1), whereby the first slurry loop reactor is connected in series with another slurry reactor (loop reactor 2), so that the first ethylene polymer fraction (A-1) produced in the loop reactor 1 is fed to the loop reactor 2, wherein the second ethylene polymer fraction (A-2) is produced in the presence of the first fraction (A-1). The loop reactor 2 is thereby connected in series to a gas phase reactor (GPR), so that the first ethylene polymer component (A) leaving the second slurry reactor is fed to the GPR to produce a trimodal polyethylene copolymer. In this case, the reaction conditions in the two slurry reactors are chosen in a way that in the two slurry reactors different products in view of MFR and/or density are produced.

Such a process is described inter alia in WO 2016/198273, WO 2021009189, WO 2021009190, WO 2021009191 and WO 2021009192. Full details of how to prepare suitable metallocene catalysed multimodal copolymer (P) can be found in these references.

A suitable process is the Borstar PE process or the Borstar PE 3G process.

The metallocene catalysed multimodal copolymer (P) according to the present invention is therefore preferably produced in a loop loop gas cascade. Such polymerization steps may be preceded by a prepolymerization step. The purpose of the prepolymerization is to polymerize a small amount of polymer onto the catalyst at a low temperature and/or a low monomer concentration. By prepolymerization it is possible to improve the performance of the catalyst in slurry and/or modify the properties of the final polymer. The prepolymerization step is preferably conducted in slurry and the amount of polymer produced in an optional prepolymerization step is counted to the amount (wt %) of ethylene polymer component (A).

The catalyst components are preferably all introduced to the prepolymerization step when a prepolymerization step is present. However, where the solid catalyst component and the cocatalyst can be fed separately it is possible that only a part of the cocatalyst is introduced into the prepolymerization stage and the remaining part into subsequent polymerization stages. Also in such cases it is necessary to introduce so much cocatalyst into the prepolymerization stage that a sufficient polymerization reaction is obtained therein.

It is understood within the scope of the invention, that the amount or polymer produced in the prepolymerization lies within 1 to 5 wt % in respect to the final metallocene catalysed multimodal copolymer (P). This can counted as part of the first ethylene polymer component (A).

### Catalyst

The metallocene catalysed multimodal copolymer (P) used in the process of the invention is one made using a metallocene catalyst. A metallocene catalyst comprises a metallocene complex and a cocatalyst. The metallocene compound or complex is referred herein also as organometallic compound (C).

The organometallic compound (C) comprises a transition metal (M) of Group 3 to 10 of the Periodic Table (IUPAC 2007) or of an actinide or lanthanide.

The term “an organometallic compound (C)” in accordance with the present invention includes any metallocene or non-metallocene compound of a transition metal, which bears at least one organic (coordination) ligand and exhibits the catalytic activity alone or together with a cocatalyst. The transition metal compounds are well known in the art and the present invention covers compounds of metals from Group 3 to 10, e.g. Group 3 to 7, or 3 to 6, such as Group 4 to 6 of the Periodic Table, (IUPAC 2007), as well as lanthanides or actinides.

In an embodiment, the organometallic compound (C) has the following formula (II):

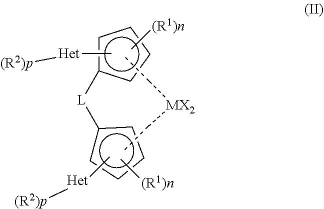

wherein each X is independently a halogen atom, a C₁₋₆-alkyl, C₁₋₆-alkoxy group, phenyl or benzyl group;
each Het is independently a monocyclic heteroaromatic group containing at least one heteroatom selected from O or S; L is —R′₂Si—, wherein each R′ is independently C₁₋₂₀-hydrocarbyl or C₁₋₁₀-alkyl substituted with alkoxy having 1 to 10 carbon atoms;
M is Ti, Zr or Hf;
each R¹ is the same or different and is a C₁₋₆-alkyl group or C₁₋₆-alkoxy group;
each n is 1 to 2;
each R² is the same or different and is a C₁₋₆-alkyl group, C₁₋₆-alkoxy group or —Si(R)₃ group;
each R is C₁₋₁₀-alkyl or phenyl group optionally substituted by 1 to 3 C₁₋₆-alkyl groups; and
each p is 0 to 1.

Preferably, the compound of formula (II) has the structure

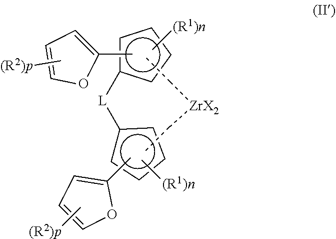

wherein each X is independently a halogen atom, a C₁₋₆-alkyl, C₁₋₆-alkoxy group, phenyl or benzyl group;
L is a Me₂Si—;
each R¹ is the same or different and is a C₁₋₆-alkyl group, e.g. methyl or t-Bu;
each n is 1 to 2;
R² is a —Si(R)₃ alkyl group; each p is 1;
each R is C₁₋₆-alkyl or phenyl group.

Highly preferred complexes of formula (II) are

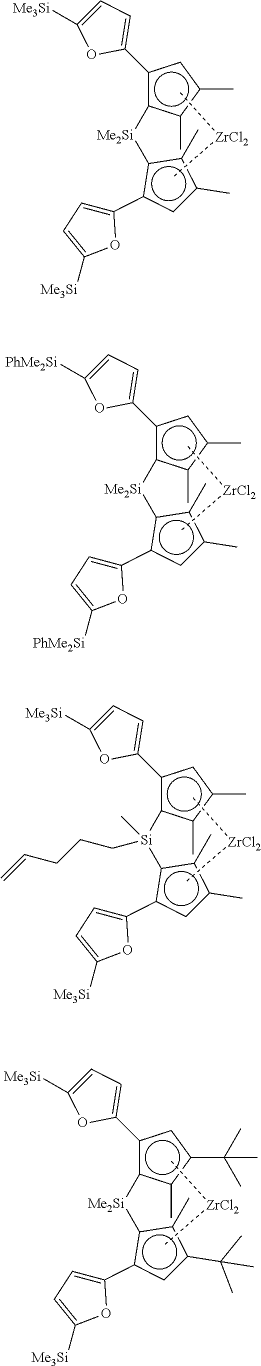

Most preferably the complex dimethylsilanediylbis[2-(5-trimethylsilylfuran-2-yl)-4,5-dimethylcyclopentadien-1-yl] zirconium dichloride is used.

More preferably the ethylene polymer components (A) and (B) of the multimodal copolymer (P) are produced using, i.e. in the presence of, the same metallocene catalyst.

To form a catalyst, a cocatalyst, also known as an activator, is used, as is well known in the art. Cocatalysts comprising Al or B are well known and can be used here. The use of aluminoxanes (e.g. MAO) or boron based cocatalysts (such as borates) is preferred.

Polyethylene copolymers made using single site catalysis, as opposed to Ziegler Natta catalysis, have characteristic features that allow them to be distinguished from Ziegler Natta materials. In particular, the comonomer distribution is more homogeneous. This can be shown using TREF or Crystaf techniques. Catalyst residues may also indicate the catalyst used. Ziegler Natta catalysts would not contain a Zr or Hf group (IV) metal for example.

The metallocene catalysed multimodal copolymer (P) may contain further polymer components and optionally additives and/or fillers. In case the metallocene catalysed multimodal copolymer (P) contains further polymer components, then the amount of the further polymer component(s) typically varies between 3.0 to 20.0 wt % based on the combined amount of the metallocene catalysed multimodal copolymer (P) and the other polymer component(s).

The optional additives and fillers and the used amounts thereof are conventional in the field of film applications. Examples of such additives are, among others, antioxidants, process stabilizers, UV-stabilizers, pigments, fillers, antistatic additives, antiblock agents, nucleating agents, acid scavengers as well as polymer processing agent (PPA).

It is understood herein that any of the additives and/or fillers can optionally be added in so-called master batch, which comprises the respective additive(s) together with a carrier polymer. In such case the carrier polymer is not calculated to the polymer components of the metallocene catalysed multimodal copolymer (P), but to the amount of the respective additive(s), based on the total amount of polymer composition (100 wt %).

### Film of the Invention

The film of the invention comprises at least one layer comprising the metallocene catalysed multimodal copolymer (P). The film can be a monolayer film comprising the metallocene catalysed multimodal copolymer (P) or a multilayer film, wherein at least one layer comprises the metallocene catalysed multimodal copolymer (P). The terms “monolayer film” and multilayer film” have well known meanings in the art.

The layer of the monolayer or multilayer film of the invention may consist of the metallocene catalysed multimodal copolymer (P) as such or of a blend of the metallocene catalysed multimodal copolymer (P) together with further polymer(s). In case of blends, any further polymer is different from the metallocene catalysed multimodal copolymer (P) and is preferably a polyolefin. Part of the above mentioned additives, like processing aids, can optionally added to the metallocene catalysed multimodal copolymer (P) during the film preparation process.

Preferably, the at least one layer of the invention comprises at least 50 wt %, more preferably at least 60 wt %, even more preferably at least 70 wt %, yet more preferably at least 80 wt %, of the metallocene catalysed multimodal copolymer (P) of the invention. Most preferably said at least one layer of the film of invention consists of the metallocene catalysed multimodal copolymer (P).

Accordingly, the films of the present invention may comprise a single layer (i.e. monolayer) or may be multilayered. Multilayer films typically, and preferably, comprise at least 3 layers.

The films are preferably produced by any conventional film extrusion procedure known in the art including cast film and blown film extrusion. Most preferably, the film is a blown or cast film, especially a blown film. E.g. the blown film is produced by extrusion through an annular die and blowing into a tubular film by forming a bubble which is collapsed between nip rollers after solidification. This film can then be slit, cut or converted (e.g. gusseted) as desired. Conventional film production techniques may be used in this regard. If the preferable blown or cast film is a multilayer film then the various layers are typically coextruded. The skilled man will be aware of suitable extrusion conditions.

Films according to the present invention may be subjected to post-treatment processes, e.g. surface modifications, lamination or orientation processes or the like. Such orientation processes can be mono-axially (MDO) or bi-axially orientation, wherein mono-axial orientation is preferred.

In another preferred embodiment, the films are unoriented.

The resulting films may have any thickness conventional in the art. The thickness of the film is not critical and depends on the end use. Thus, films may have a thickness of, for example, 300 μm or less, typically 6 to 200 μm, preferably 10 to 180 μm, e.g. 20 to 150 μm or 20 to 120 μm. If desired, the polymer of the invention enables thicknesses of less than 100 μm, e.g. less than 50 μm. Films of the invention with thickness even less than 20 μm can also be produced whilst maintaining good mechanical properties.

Furthermore, the present invention is also directed to the use of the inventive article as packing material, in particular as a packing material for food and/or medical products.

The films of the invention are characterized by a dart-drop impact strength (DDI) determined according to ASTM D1709, method A on a 40 μm monolayer test blown film of at least 780 g to 1500 g, preferably 800 g to 1200 g and more preferably 850 g to 1000 g.

Films according to the present invention furthermore have good stiffness (tensile modulus measured on a 40 μm monolayer test blown film according to ISO 527-3), i.e. >180 MPa (in both directions) and good optics, i.e. haze (measured on a 40 μm monolayer test blown film according to ASTM D 1003-00) of below 25%.

Thus, the films comprising the metallocene catalysed multimodal copolymer (P) may further or in addition have a haze (measured on a 40 μm monolayer test blown film according to ASTM D 1003-00) of below 25%, preferably between 5% and 24%, more preferably between 10% and 23% and a tensile modulus (measured on a 40 μm monolayer test blown film according to ISO 527-3) in machine (MD) as well as in transverse (TD) direction in the range of from >180 MPa to 350 MPa, preferably of from 200 MPa to 300 MPa.

In one further embodiment of the present invention, the optomechanical ability (OMA) according to formula (I):

$$OMA = \frac{Tensile Modulus ( MD ) [ MPa ] * DDI ( g )}{Haze ( 40 μm ) [ \% ]}$$

of films determined on a 40 μm test blown film is at least 7800 [MPa*g/%] up to 15 000 [MPa*g/%], preferably in the range of from 8000 [MPa*g/%] up to 12 000 [MPa*g/%], more preferably in the range of from 8200 [MPa*g/%] up to 10 000 [MPa*g/%], wherein the Tensile Modulus in machine direction is measured according to ISO 527-3 at 23° C. on 40 μm blown films, DDI is the dart-drop impact strength determined according to ASTM D1709, method A on a 40 μm blown film and haze is measured according to ASTM D1003 on a 40 μm blown film.

In view of the present invention, optomechanical ability (OMA) is understood as the ratio of mechanical (especially dart-drop impact strength (DDI) and tensile (MD)) behaviour, to optical performance, namely haze, wherein the mechanical properties are targeted to be as high as possible and the optical performance in the sense of haze is desired to be as low as possible.

The invention will be further described with reference to the following non-limiting examples.

### Determination Methods:

Unless otherwise stated in the description or in the experimental part, the following methods were used for the property determinations of the polymers (including its fractions and components) and/or any sample preparations thereof as specified in the text or experimental part.

### Melt Flow Rate

The melt flow rate (MFR) was determined according to ISO 1133 and is indicated in g/10 min. The MFR is an indication of the flowability, and hence the processability, of the polymer. The higher the melt flow rate, the lower the viscosity of the polymer. The MFR is determined at 190° C. for polyethylene. MFR may be determined at different loadings such as 2.16 kg (MFR₂), 5 kg (MFR₅) or 21.6 kg (MFR₂₁).

### Calculation of MFR2 of Component B and of Fraction (A-2)

For Component B:
B=MFR2 of Component (A)
C=MFR2 of Component (B)
A=final MFR2 (mixture) of multimodal polyethylene copolymer (P)
X=weight fraction of Component (A)

For Fraction (A-2):
B=MFR2 of 1st fraction (A-1)
C=MFR2 of 2nd fraction (A-2)
A=final MFR2 (mixture) of loop polymer (=Component (A))
X=weight fraction of the 1st fraction (A-1)

### Density

Density of the polymer was measured according to ASTM; D792, Method B (density by balance at 23° C.) on compression moulded specimen prepared according to EN ISO 1872-2 and is given in kg/m³.

### Comonomer Contents:

### Quantification of Microstructure by NMR Spectroscopy

Quantitative nuclear-magnetic resonance (NMR) spectroscopy was used to quantify the comonomer content of the polymers.

Quantitative ¹³C{¹H} NMR spectra recorded in the molten-state using a Bruker Avance Ill 500 NMR spectrometer operating at 500.13 and 125.76 MHz for ¹H and ¹³C respectively. All spectra were recorded using a ¹³C optimized 7 mm magic-angle spinning (MAS) probehead at 150° C. using nitrogen gas for all pneumatics. Approximately 200 mg of material was packed into a 7 mm outer diameter zirconia MAS rotor and spun at 4 kHz.

This setup was chosen primarily for the high sensitivity needed for rapid identification and accurate quantification {klimke06, parkinson07, castignolles09}. Standard single-pulse excitation was employed utilizing the NOE at short recycle delays of 3 s {pollard04, klimke06} and the RS-HEPT decoupling scheme{fillip05,griffin07}. A total of 1024 (1k) transients were acquired per spectra.

Quantitative ¹³C{¹H} NMR spectra were processed, integrated and relevant quantitative properties determined from the integrals. All chemical shifts are internally referenced to the bulk methylene signal (δ+) at 30.00 ppm.

The amount of ethylene was quantified using the integral of the methylene (6+) sites at 30.00 ppm accounting for the number of reporting sites per monomer:

$$E = {I}_{δ +} / 2$$

the presence of isolated comonomer units is corrected for based on the number of isolated comonomer units present:

$$Etotal = E + ( 3 * B + 2 * H ) / 2$$

where B and H are defined for their respective comonomers. Correction for consecutive and non-consecutive commoner incorporation, when present, is undertaken in a similar way.

Characteristic signals corresponding to the incorporation of 1-butene were observed and the comonomer fraction calculated as the fraction of 1-butene in the polymer with respect to all monomer in the polymer:

$$fBtotal = Btotal / ( Etotal + Btotal + Htotal )$$

The amount isolated 1-butene incorporated in EEBEE sequences was quantified using the integral of the _{*}B2 sites at 39.8 ppm accounting for the number of reporting sites per comonomer:

$$B = {I}_{* B2}$$

If present the amount consecutively incorporated 1-butene in EEBBEE sequences was quantified using the integral of the ααB2B2 site at 39.4 ppm accounting for the number of reporting sites per comonomer:

$$BB = 2 * I αα B 2 B 2$$

If present the amount non consecutively incorporated 1-butene in EEBEBEE sequences was quantified using the integral of the ββ2B2 site at 24.6 ppm accounting for the number of reporting sites per comonomer:

$$BEB = 2 * I ββ B 2 B 2$$

Due to the overlap of the *B2 and *(3B2B2 sites of isolated (EEBEE) and non-consecutively incorporated (EEBEBEE) 1-butene respectively the total amount of isolated 1-butene incorporation is corrected based on the amount of non-consecutive 1-butene present:

$$B = {I}_{* B 2} - 2 * {I}_{β β B 2 B 2}$$

Sequences of BBB were not observed. The total 1-butene content was calculated based on the sum of isolated, consecutive and non consecutively incorporated 1-butene:

$$Btotal = B + B B + B E B$$

The total mole fraction of 1-butene in the polymer was then calculated as:

$$fB = Btotal / ( Etotal + Btotal + Htotal )$$

Characteristic signals corresponding to the incorporation of 1-hexene were observed and the comonomer fraction calculated as the fraction of 1-hexene in the polymer with respect to all monomer in the polymer:

$$fHtotal = Htotal / ( Etotal + Btotal + Htotal )$$

The amount isolated 1-hexene incorporated in EEHEE sequences was quantified using the integral of the _{*}B4 sites at 38.3 ppm accounting for the number of reporting sites per comonomer:

$$H = {I}_{* B 4}$$

If present the amount consecutively incorporated 1-hexene in EEHHEE sequences was quantified using the integral of the ααB4B4 site at 40.5 ppm accounting for the number of reporting sites per comonomer:

$$HH = 2 * I αα B 4 B 4$$

If present the amount non consecutively incorporated 1-hexene in EEHEHEE sequences was quantified using the integral of the ββB4B4 site at 24.7 ppm accounting for the number of reporting sites per comonomer:

$$HEH = 2 * I ββ B 4 B 4$$

Sequences of HHH were not observed. The total 1-hexene content was calculated based on the sum of isolated, consecutive and non consecutively incorporated 1-hexene:

$$Htotal = H + H H + H E H$$

The total mole fraction of 1-hexene in the polymer was then calculated as:

$$fH = Htotal / ( Etotal + Btotal + Htotal )$$

The mole percent comonomer incorporation is calculated from the mole fraction:

$$B [ mol \% ] = 100 * fB$$

$$H [ mol \% ] = 100 * fH$$

The weight percent comonomer incorporation is calculated from the mole fraction:

$$B [ wt \% ] = 100 * ( fB * 56.11 ) / ( ( fB * 56.11 ) + ( fH * 84.16 ) + ( ( 1 - ( fB + fH ) ) * 28.05 ) )$$

$$H [ wt \% ] = 100 * ( fH * 84.16 ) / ( ( fB * 56.11 ) + ( fH * 84.16 ) + ( ( 1 - ( fB + fH ) ) * 28.05 ) )$$

### REFERENCES

Klimke, K., Parkinson, M., Piel, C., Kaminsky, W., Spiess, H. W., Wilhelm, M., Macromol. Chem. Phys. 2006; 207:382.
Parkinson, M., Klimke, K., Spiess, H. W., Wilhelm, M., Macromol. Chem. Phys. 2007; 208:2128.
Pollard, M., Klimke, K., Graf, R., Spiess, H. W., Wilhelm, M., Sperber, O., Piel, C., Kaminsky, W., Macromolecules 2004; 37:813.
Filip, X., Tripon, C., Filip, C., J. Mag. Resn. 2005, 176, 239
Griffin, J. M., Tripon, C., Samoson, A., Filip, C., and Brown, S. P., Mag. Res. in Chem. 2007 45, S1, S198
Castignolles, P., Graf, R., Parkinson, M., Wilhelm, M., Gaborieau, M., Polymer 50 (2009) 2373
Busico, V., Cipullo, R., Prog. Polym. Sci. 26 (2001) 443
Busico, V., Cipullo, R., Monaco, G., Vacatello, M., Segre, A. L., Macromoleucles 30 (1997) 6251
Zhou, Z., Kuemmerle, R., Qiu, X., Redwine, D., Cong, R., Taha, A., Baugh, D. Winniford, B., J. Mag. Reson. 187 (2007) 225
Busico, V., Carbonniere, P., Cipullo, R., Pellecchia, R., Severn, J., Talarico, G., Macromol. Rapid Commun. 2007, 28, 1128
Resconi, L., Cavallo, L., Fait, A., Piemontesi, F., Chem. Rev. 2000, 100, 1253

### Molecular Weights, Molecular Weight Distribution, Mn, Mw, MWD:

Molecular weight averages (Mz, Mw and Mn), Molecular weight distribution (MWD) and its broadness, described by polydispersity index, PDI=Mw/Mn (wherein Mn is the number average molecular weight and Mw is the weight average molecular weight) were determined by Gel Permeation Chromatography (GPC) according to ASTM D 6474-12 using the following formulas:

$${M}_{n} = \frac{{\sum }_{i = 1}^{N} {A}_{i}}{{\sum }_{i = 1}^{N} ( {A}_{i} / {M}_{i} )} \qquad ( 1 )$$

$${M}_{w} = \frac{{\sum }_{i = 1}^{N} ( {A}_{i} \times {M}_{i} )}{{\sum }_{i = 1}^{N} {A}_{i}} \qquad ( 2 )$$

$${M}_{z} = \frac{{\sum }_{i = 1}^{N} ( {A}_{i} \times {M}_{i}^{2} )}{{\sum }_{i = 1}^{N} ( {A}_{i} \times {M}_{i} )} \qquad ( 3 )$$

For a constant elution volume interval ΔVᵢ, where Aᵢ, and Mᵢ are the chromatographic peak slice area and polyolefin molecular weight (MW), respectively associated with the elution volume, Vᵢ, where N is equal to the number of data points obtained from the chromatogram between the integration limits.

A high temperature GPC instrument, equipped with either infrared (IR) detector (IR4 or IR5 from PolymerChar (Valencia, Spain) or differential refractometer (RI) from Agilent Technologies, equipped with 3×Agilent-PLgel Olexis and 1×Agilent-PLgel Olexis Guard columns was used. As the solvent and mobile phase 1,2,4-trichlorobenzene (TCB) stabilized with 250 mg/L 2,6-Di tert butyl-4-methyl-phenol) was used. The chromatographic system was operated at 160° C. and at a constant flow rate of 1 mL/min. 200 μL of sample solution was injected per analysis. Data collection was performed using either Agilent Cirrus software version 3.3 or PolymerChar GPC-IR control software.

The column set was calibrated using universal calibration with 19 narrow MWD polystyrene (PS) standards in the range of 0.5 kg/mol to 11 500 kg/mol. The PS standards were dissolved at room temperature over several hours. The conversion of the polystyrene peak molecular weight to polyolefin molecular weights is accomplished by using the Mark Houwink equation and the following Mark Houwink constants:

$${K}_{PS} = 19 \times {10}^{- 3} mL / g , {α}_{PS} = 0 \text{.655}$$

$${K}_{PE} = 39 \times {10}^{- 3} mL / g , {α}_{PE} = 0.725$$

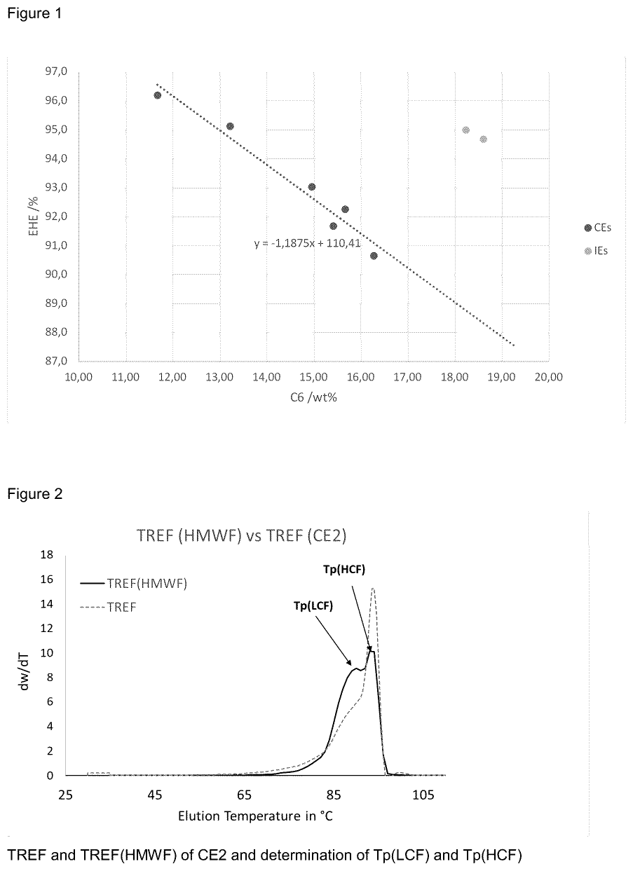

FIG. 1 shows a plot of C6/wt % versus EHE/% with a line of fit of EHE/%=−1,1875 (C6/wt %)+110,41.

A third order polynomial fit was used to fit the calibration data.

All samples were prepared in the concentration range of 0,5−1 mg/ml and dissolved at 160° C. for 3 hours for PE under continuous gentle shaking.

### Mw(Tp(LCF)/Mw(Tp(HCF) and Half Peak Breadth (LCF) of TREF Profile Log M>5,2

The chemical composition distribution as well as the determination of the molecular weight distribution and the corresponded molecular weight averages (Mn, Mw and Mv) at a certain elution temperature (polymer crystallinity in solution) were determined by a full automated Cross Fractionation Chromatography (CFC) as described by Ortin A., Monrabal B., Sancho-Tello J., Macromol. Symp., 2007, 257, 13-28.

A CFC instrument (PolymerChar, Valencia, Spain) was used to perform the cross-fractionation chromatography (TREF×SEC). A four-band IR5 infrared detector (PolymerChar, Valencia, Spain) was used to monitor the concentration. Around 40 mg of the polymer sample was dissolved in 25 ml TCB in the stainless steel vessel for 150 min at 150° C. Once the sample was completely dissolved an aliquot of 0.5 ml was loaded into the TREF column and stabilized for 60 minutes at 110° C. The polymer was crystallized and precipitate to a temperature of 30° C. by applying a constant cooling rate of 0.1° C./min. A discontinuous elution process is performed using the following temperature steps: (30, 40, 45, 50, 53, 56, 59, 62, 64, 66, 69, 72, 76, 79, 82, 85, 89, 91, 93, 95, 97, 100, 110, and 120) In the second dimension, the GPC analysis, 3 PL Olexis columns and 1× Olexis Guard columns from Agilent (Church Stretton, UK) were used as stationary phase. As eluent 1,2,4-trichlorobenzene (TCB, stabilized with 250 mg/L 2,6-Di tert butyl-4-methyl-phenol) at 150° C. and a constant flow rate of 1 mL/min were applied. The column set was calibrated using universal calibration (according to ISO 16014-2:2003) with at least 15 narrow MWD polystyrene (PS) standards in the range of 0.5 kg/mol to 11 500 kg/mol. Following Mark Houwink constants were used to convert PS molecular weights into the PE molecular weight equivalents.

$${K}_{PS} = 19 \times {10}^{- 3} mL / g , {α}_{PS} = 0 \text{.655}$$

$${K}_{PE} = 39 \times {10}^{- 3} mL / g , {α}_{PP} = 0.725$$

A third order polynomial fit was used to fit the calibration data. Data processing was performed using the software provided from PolymerChar with the CFC instrument.

In the first step to obtain better resolved TREF peaks for high crystalline fraction (HCF) and low crystalline fraction (LCF), an a-TREF curve exclusively considering only high molecular weight fraction was created. Therefore the polymer fraction with a molar mass higher than log M of 5.2 (˜158 000 g/mol) were considered to obtain a-TREF curve of the high molecular weight fraction. (a-TREF(HMWF)). This is especially of advantage if the comonomer content in the high crystalline fraction and in the low crystalline fraction are similar, meaning that the temperature difference in the peak position of HCF and LCF are less than 20° C.

From the a-TREF(HMWF) the peak maximum of the HCF peak (Tp(HCF)) and LCF peak were determined (Tp(LCF), where the Tp(HCF) was higher than Tp(LCF) and smaller than 99° C. In FIG. 2 the a-TREF(HMWF) and the a-TREF profile of CE2 are shown.

In the next step the Mw at the elution temperature of Tp(LCF) and Tp(HCF) were determined. Therefore the Mw at the Tp(LCF) (Mw(Tp(LCF)) was calculated by a linear interpolation between the measured Mw values by GPC of the elution temperatures which was above the Tp(LCF) and below Tp(LCF). This was achieved by using e.g. “TREND” function in Excel.

The same procedure was done to determine the Mw at Tp(HCF).

From the obtained Tp(LCF) of the a-TREF (HMWF) curve the half peak breadth was defined as the elution temperature difference between the front temperature and the rear temperature at the half of the maximum peak height of Tp(LCF). The correspondent front temperature was searched forward from 35° C., while the rear temperature at the half of the maximum was searched backwards from 100° C., if the peaks are not well separated. If the LCF is well separated from HCF then the rear temperature was searched after the HCF.

### Dart Drop Strength (DDI)

Dart-drop was measured using ASTM D1709, method A (Alternative Testing Technique) from the films as produced indicated below. A dart with a 38 mm diameter hemispherical head was dropped from a height of 0.66 m onto a multilayer film clamped over a hole.

Successive sets of twenty specimens were tested. One weight was used for each set and the weight was increased (or decreased) from set to set by uniform increments. The weight resulting in failure of 50% of the specimens was calculated and reported.

### Tensile Modulus

Tensile modulus (E-Mod (MPa) was measured in machine and/or transverse direction according to ISO 527-3 on film samples prepared as described under the Film Sample preparation with film thickness of 40 μm and at a cross head speed of 1 mm/min for the modulus.

### Haze

Haze was determined according to ASTM D 1003-00 on films as produced indicated below.

### Film Sample Preparation

The monolayer test films consisting of the inventive multimodal copolymer (P) and respective comparative polymers of 40 μm thickness, were prepared using a Collin 25 benchscale line. Film samples were produced with BUR 2.5:1. Melt temperature 199° C. and frost line distance 100 mm, screw speed 126 rpm and take off speed 7.3 m/min.

### Experimental Part

### Cat.Example: Catalyst Preparation for IE1 (CAT1)

### Loading of SiO2:

10 kg of silica (PQ Corporation ES757, calcined 600° C.) was added from a feeding drum and inertized in the reactor until 02 level below 2 ppm was reached.

### Preparation of MAO/tol/MC:

30 wt % MAO in toluene (14.1 kg) was added into another reactor from a balance followed by toluene (4.0 kg) at 25° C. (oil circulation temp) and stirring 95 rpm. Stirring speed was increased 95 rpm!200 rpm after toluene addition, stirring time 30 min. Metallocene Rac-dimethylsilanediylbis{2-(5-(trimethylsilyl)furan-2-yl)-4,5-dimethylcyclopentadien-1-yl}zirconium dichloride 477 g was added from a metal cylinder followed by flushing with 4 kg toluene (total toluene amount 8.0 kg). Reactor stirring speed was changed to 95 rpm for MC feeding and returned back to 200 rpm for 3 h reaction time. After reaction time MAO/tol/MC solution was transferred into a feeding vessel.

### Preparation of Catalyst:

Reactor temperature was set to 10° C. (oil circulation temp) and stirring 40 rpm for MAO/tol/MC addition. MAO/tol/MC solution (target 22.5 kg, actual 22.2 kg) was added within 205 min followed by 60 min stirring time (oil circulation temp was set to 25° C.). After stirring “dry mixture” was stabilised for 12 h at 25° C. (oil circulation temp), stirring 0 rpm. Reactor was turned 20° (back and forth) and stirring was turned on 5 rpm for few rounds once an hour.

After stabilisation the catalyst was dried at 60° C. (oil circulation temp) for 2 h under nitrogen flow 2 kg/h, followed by 13 h under vacuum (same nitrogen flow with stirring 5 rpm). Dried catalyst was sampled and HC content was measured in the glove box with Sartorius Moisture Analyser, (Model MA45) using thermogravimetric method. Target HC level was <2% (actual 1.3%).

### Catalyst for Comparative Examples (CAT2)

As catalyst CAT2 an alumoxane containing, supported catalyst containing metallocene bis(1-methyl-3-n-butylcyclopentadienyl) zirconium (IV) chloride and with enhanced ActivCat® activator technology from Grace was used.

### Polymerization: Inventive Examples: Inventive Multimodal Polyethylene Copolymer (P) with 1-Butene and 1-Hexene Comonomers

Borstar pilot plant with a 3-reactor set-up (loop1-loop2-GPR 1) and a prepolymerization loop reactor.

The inventive multimodal copolymers (P) of example 1 (IE1) as well as of the comparative example (CE1) were produced by using the polymerization conditions as given in Table 1.

TABLE 1
Polymerization conditions

| | IE1 | CE1 |
|---|---|---|
| Prepoly reactor | | |
| Catalyst | CAT1 | CAT2 |
| Catalyst feed (g/h) | 66.80 | 43.28 |
| Temp. (° C.) | 50 | 50 |
| Press. (kPa) | 5811 | 5706 |
| C2 (kg/h) | 4.0 | 4.0 |
| H2(g/h) | 0.69 | 0.04 |
| C4 (g/h) | 83.70 | 149.98 |
| Split (wt %) | 3.1 | 3.5 |
| loop 1 Fraction (A-1) | | |
| Temp. (° C.) | 85 | 85 |
| Press. (kPa) | 5542 | 5520 |
| C2 conc. (mol %) | 2.96 | 3.42 |
| H2/C2 ratio (mol/kmol) | 0.43 | 0.42 |
| C4/C2 ratio (mol/kmol) | 55.78 | 75.90 |
| Split (wt %) | 18.2 | 19.0 |
| Density (kg/m3) of loop 1 material (fraction (A-1)) | 940 | 941 |
| MFR2 (g/10 min) of loop 1 material (fraction (A-1)) | 6.2 | 5.9 |
| loop 2 | | |
| Temp. (° C.) | 85.0 | 85 |
| Press. (kPa) | 5362 | 5329 |
| C2 conc. (mol %) | 4.28 | 3.73 |
| H2/C2 ratio (mol/kmol) | 0.31 | 0.06 |
| C4/C2 ratio (mol/kmol) | 80.77 | 85.80 |
| Split (wt %) | 19.2 | 20.0 |
| Density (kg/m3) after loop 2 (component (A)) | 938 | 942 |
| MFR2 (g/10 min) after loop 2 (component (A)) | 6.0 | 7.4 |
| MFR2 (g/10 min) of loop 2 material (fraction (A-2)) | 5.8 | 9.5 |
| Density (kg/m3) of loop 2 material (fraction (A-2)) | 936 | 943 |
| C4 (mol %) after loop 2 material (Component (A)) | 0.74 | 0.47 |
| GPR | | |
| Temp. (° C.) | 75.0 | 75.0 |
| Press. (kPa) | 2000.1 | 1999.9 |
| H2/C2 ratio (mol/kmol) | 0.93 | 0.23 |
| C6/C2 ratio (mol/kmol) | 9.82 | 34.00 |
| Split (wt %) | 59.6 | 57.5 |
| MFR2 (g/10 min) of GPR material (Component (B)) | 0.4 | 0.5 |
| Density (kg/m3) of GPR material (Component (B)) | 907.5 | 902.9 |
| C6 (mol %) of GPR material Component (B)) | 4.54 | 5.22 |

The polymers were mixed with 2400 ppm of Irganox B561, 270 ppm of Dynamar FX 5922 compounded and extruded under nitrogen atmosphere to pellets by using a twin screw extruder ZSK18; melt temperature 192° C.

TABLE 2
Material properties of inventive multimodal copolymer (P)
and comparative copolymer, as well as film parameters

| | IE1 | CE1 |
|---|---|---|
| Material | | |
| MFR₂ (g/10 min) (final) | 1.25 | 1.64 |
| Density (kg/m³) | 919.4 | 918.5 |
| C4 (mol %) | 0.3 | 0.2 |
| C6 (mol %) | 2.7 | 3.0 |
| Mn (kg/mol) | 16.7 | 19.85 |
| Mw (kg/mol) | 89.85 | 88.8 |
| Mw/Mn | 5.38 | 4.46 |
| Mw(Tp(LCF)/Mw(Tp(HCF)* | 2.5 | 1.3 |
| Half peak breadth (LCF) of TREF profile | 9.8 | 21.1 |
| LogM > 5.2 | | |
| Film Properties | | |
| DDI [g] | 880 | 775 |
| Tensile Modulus MPa (MD/TD) | 215/245 | 172/184 |
| Haze | 21.5 | 17.3 |
| OMA | 8800 | 7705 |

*HCF: High crystalline fraction/LCF: Low crystalline fraction. CFC data.

From the above table it can be clearly seen, that films consisting of the inventive multimodal copolymer (P) show a higher DDI and Tensile Modulus compared to the comparative example.

Furthermore, such films have an improved overall performance, i.e. higher OMA.

1.-14. (canceled)

15. A metallocene-catalysed multimodal polyethylene copolymer (P), which consists of:
(i) 35.0 to 50.0 wt % of an ethylene-1-butene polymer component (A), and
(ii) 50.0 to 65.0 wt % of an ethylene-1-hexene polymer component (B),
wherein the ethylene-1-butene polymer component (A) has;
a density in a range of from 920 to 950 kg/m³,
an MFR₂ (190° C., 2.16 kg, ISO 1133) in a range of from 2.0 to 20.0 g/10 min,
a 1-butene content in a range of 0.1 to 2.0 mol %, based on the ethylene-1-butene polymer component (A);
wherein ethylene-1-butene polymer component (A) consists of an ethylene-1-butene polymer fraction (A-1) and an ethylene-1-butene polymer fraction (A-2),
wherein the ethylene polymer fraction (A-1) has a density in a range of from 920 to 960 kg/m3 and an MFR2 (190° C., 2.16 kg, ISO 1133) in a range of from 1.0 to 15.0 g/10 min, and
the ethylene polymer fraction (A-2) has a density in a range of from 925 to 950 kg/m³, and an MFR2 and (190° C., 2.16 kg, ISO 1133) a range of 1.0 to 15.0 g/10 min;
wherein the ethylene polymer component (B) has;
a density in a range of from 890 to 920 kg/m³,
an MFR₂ (190° C., 2.16 kg, ISO 1133) in a range of from 0.1 to 2.0 g/10 min,
a 1-hexene content in a range of 2.5 to 10.0 mol % based on the ethylene-1-hexene polymer compound (B);
wherein the multimodal polyethylene copolymer (P) has;
a density in a range of from 915 to 925 kg/m³,
an MFR₂ (190° C., 2.16 kg, ISO 1133) in a range of from 1.0 to 3.0 g/10 min,
a molecular weight distribution, Mw/Mn, determined with GPC in a range of at least 4.6 up to 7.0,
a ratio of the weight average molecular weight, Mw of the low crystalline fraction (LCF) to the weight average molecular weight (Mw) of the high crystalline fraction (HCF), Mw(Tp(LCF)/Mw(Tp(HCF), determined as described in an experimental part In a range of from 1.8 to 4.0, and
a half peak breadth of the low crystalline fraction (LCF) in a TREF profile with Log M>5.2, determined as described in the experimental part, in a range of 5.0 to 20.0.

16. The metallocene-catalysed multimodal polyethylene copolymer (P) according to claim 15, wherein ethylene-1-butene polymer component (A) consists of the ethylene-1-butene polymer fraction (A-1) and the ethylene-1-butene polymer fraction (A-2),
wherein the ethylene polymer fraction (A-1) has a density in a range of from 925 to 955 kg/m³ and an MFR₂ (190° C., 2.16 kg, ISO 1133) in a range of from 1.5 to 14.0 g/10 min; and
the ethylene polymer fraction (A-2) has a density in a range of from 930 to 940 kg/m³, and an MFR₂ and (190° C., 2.16 kg, ISO 1133) a range of 1.5 to 14.0 g/10 min.

17. The metallocene-catalysed multimodal copolymer (P) according to claim 15, wherein the ethylene polymer component (A) has an MFR₂ (190° C., 2.16 kg, ISO 1133) of 2.5 to 16 g/10 min, and/or of 3.0 to 12.0 g/10 min, and/or of 3.5 to 10 g/10 min and
the ethylene polymer component (B) has an MFR₂ (190° C., 2.16 kg, ISO 1133) of 0.2 to 1.6 g/10 min, and/or of 0.3 to 1.2 g/10 min, and/or of 0.3 to 1.0 g/10 min.

18. The metallocene-catalysed multimodal copolymer (P) according to claim 15, wherein a total amount of 1-butene, based on the multimodal polymer (P) is in a range of from 0.1 to 1.0 mol %, and/or 0.2 to 0.8 mol % and/or 0.2 to 0.6 mol %; and
a total amount of 1-hexene, based on the multimodal polymer (P) is in a range of 1.5 to 8.0 mol %, and/or 2.0 to 6.0 mol %, and/or 2.2 to 4.0 mol %.

19. The metallocene-catalysed multimodal copolymer (P) according to claim 15, wherein a total amount (wt %) of 1-butene, present in the ethylene-1-butene polymer component (A) is 0.1 to 2.0 mol %, and/or of 0.2 to 1.6 mol %, and/or of 0.3 to 1.2 mol %, and/or of 0.4 to 1.0 mol %, based on the ethylene-1-butene polymer component (A); and
a total amount of 1-hexene, present in the ethylene-1-hexene polymer component (B) is 3.0 to 8.0 mol %, and/or of 3.5 to 6.0 mol %, based on the ethylene-1-hexene polymer component (B).

20. The metallocene-catalysed multimodal copolymer (P) according to claim 15, wherein the ethylene polymer component (A) is present in an amount of 35.0 to 50.0 wt % based on the multimodal copolymer (P), and/or in an amount of 36.0 to 48.0 wt %, and/or in an amount of 38.0 to 45.0 wt %, based on the multimodal copolymer (P); and
the ethylene polymer component (B) is present in an amount of 50.0 to 65.0 wt % based on the multimodal copolymer (P), and/or in an amount of 52.0 to 64.0 wt %, and/or in an amount of 55.0 to 62.0 wt %, based on the multimodal copolymer (P).

21. The metallocene-catalysed multimodal copolymer (P) according to claim 15, wherein the multimodal copolymer (P) is produced in a presence of metallocene complex of formula (II): 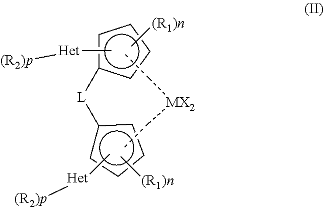
wherein each X is independently a halogen atom, a C₁₋₆-alkyl, C₁₋₆-alkoxy group, phenyl or benzyl group;
each Het is independently a monocyclic heteroaromatic group containing at least one heteroatom selected from O or S;
L is —R′₂Si—, wherein each R′ is independently C₁₋₂₀-hydrocarbyl or C₁₋₁₀-alkyl substituted with alkoxy having 1 to 10 carbon atoms;
M is Ti, Zr or Hf;
each R₁ is the same or different and is a C₁₋₆-alkyl group or C₁₋₆-alkoxy group;
each n is 1 to 2;
each R₂ is the same or different and is a C₁₋₆-alkyl group, C₁₋₆-alkoxy group or —Si(R)₃ group;
each R is C₁₋₁₀-alkyl or phenyl group optionally substituted by 1 to 3 C₁₋₆-alkyl groups; and
each p is 0 to 1.

22. A film comprising;
a metallocene-catalysed multimodal copolymer (P) according to claim 15.

23. A film according to claim 22, comprising:
at least one layer containing the metallocene-catalysed multimodal copolymer (P), whereby the at least one layer includes at least 50 wt %, and/or at least 60 wt %, and/or at least 70 wt %, yet-m e and/or at least 80 wt %, of the metallocene catalysed multimodal copolymer.

24. A film according to claim 22, configured with a dart-drop impact strength (DDI) determined according to ASTM D1709, method A on a 40 μm monolayer test blown film of at least 780 g to 1500 g, and/or 800 g to 1200 g, and/or 850 g to 1000 g.

25. A film according to claim 22, configured with a tensile modulus (measured on a 40 μm monolayer test blown film according to ISO 527-3) in machine (MD) as well as in transverse (TD) direction in a range of from >180 MPa to 350 MPa, and/or of from 200 MPa to 300 MPa.

26. A film according to claim 22, configured with a haze (measured on a 40 μm monolayer test blown film according to ASTM D 1003-00) of below 25%, and/or between 5% and 24%, more and/or between 10% and 23%.

27. A film according to claim 22, configured with a optomechanical ability (OMA) according to formula (I):
$$O M A = \frac{Tensile Modulus ( MD ) [ MPa ] * D D I ( g )}{Haze ( 40 µm ) [ \% ]}$$
of at least 7800 [MPa*g/%] up to 15 000 [MPa*g/%], and/or in a range of from 8000 [MPa*g/%] up to 12 000 [MPa*g/%], and/or in a range of from 8200 [MPa*g/%] up to 10 000 [MPa*g/%], wherein the Tensile Modulus in machine direction is measured according to ISO 527-3 at 23° C. on 40 μm test blown films, DDI is a dart-drop impact strength determined according to ASTM D1709, method A on a 40 μm test blown film and haze is measured according to ASTM D1003 on a 40 μm test blown film.

28. The use of a film according to claim 22, configured as packing material, for food and/or medical products.
